(19) United States
(12) Patent Application Publication
(10) Pub. No.: US 2017/0176780 A1
(43) Pub. Date: Jun. 22, 2017

(54) SEMICONDUCTOR WAVEGUIDE STRUCTURE

(71) Applicant: YISSUM RESEARCH DEVELOPMENT COMPANY OF THE HEBREW UNIVERSITY OF JERUSALEM LTD., Jerusalem (IL)

(72) Inventors: Uriel LEVY, Kiriat Ono (IL); Joseph SHAPPIR, Tel Aviv (IL); Ilya GOYKHMAN, Kiryat Motzkin (IL); Boris DESIATOV, Jerusalem (IL)

(73) Assignee: Yissum Research Development Company of the Hebrew University of Jerusalem Ltd., Givat Ram, Jerusalem (IL)

(21) Appl. No.: 15/300,700

(22) PCT Filed: Apr. 2, 2015
(86) PCT No.: PCT/IL2015/050370

§ 371 Date: Sep. 29, 2016

Related U.S. Application Data
(60) Provisional application No. 61/974,013, filed on Apr. 2, 2014.

(51) Int. Cl. G02F 1/025; G02F 1/225; G02B 6/293

(52) U.S. Cl. CPC G02F 1/025; G02B 6/29338; G02F 1/2257; G02F 2001/0151

(57) ABSTRACT

A waveguide device is provided. The device comprises a semiconductor waveguide structure and at least one charge storing structure. Said at least one charge storing structure is configured to apply selected electric field on the semiconductor waveguide structure to thereby vary refractive index within said semiconductor waveguide structure. Wherein the charge storing structure comprises a charge trapping layer configured for storing charge carriers configured for selectively generating constant electric field of a predetermined magnitude. The device may be used in optical resonators, interferometer for optical and optoelectronic applications, capable of desirably varying refractive index within the waveguide structure.

### TECHNOLOGICAL FIELD

The invention is in the field of semiconductor and optoelectronic devices, and relates to a semiconductor waveguide structure with tunable optical performance of the waveguide.

### BACKGROUND

Photonic resonators are known as forming a basic building block in photonic circuits, allowing diverse functionalities to be constructed within optical systems. Typical applications of photonic resonators include but not limited to modulation, switching, filtering, wavelength selection and dispersion control in optical communication and optical signal processing systems, biosensing and chemical sensing and lasers.

One of the issues related to the use of photonic resonators in optical systems is the accuracy in setting the resonance wavelength. The actual resonance wavelength may deviate from the designed one due to fabrication imperfections and environmental effects (e.g. temperature change). The issue of fabrication imperfections restricts the applicability of photonic resonators primarily in on-chip configurations. For example, given two resonators which are designed for two different resonance frequencies, separated by 100 GHz, fabrication imperfection may lead to a lower or higher separation, e.g. 95 GHz. This deviation can be compensated by controlling the refractive index of the medium. This can be done either actively, e.g. by the use of the thermo optic effect or by applying a constant voltage for proposes injecting or depleting charge carriers from the structure, or passively, by the use of trimming approaches. The thermo optic approach needs a constant power supply for heating the structure. In addition, maintaining a constant difference in temperature between two adjacent resonators on a chip is challenging. The trimming approach has been used before for polymer and glass structures.

### General Description

There is a need in the art for novel semiconductor optical device including waveguide structure(s), e.g. made of silicon, GaAs or InGaAs based material composition. There is need of such devices which allow static and/or dynamic tuning of the refractive index of the waveguide structure. Such tuning of the refractive index is typically beneficial for producing and operating optical resonators, e.g. ring resonator waveguide, Fabri-Parot resonator or photonic crystal resonator, as proper tuning of the refractive index provides control over the resonance frequencies, as well as over variation of optical path for light passing through a waveguide structure.

In the case of optical resonator, providing a static variation to the resonance frequency is generally referred to herein as “trimming” Considering static or dynamic variation of the optical properties of a waveguide structure, being a resonator or not, the present invention provides for highly accurate, editable variation of the refractive index that can be kept stable for long periods of time (tens of years) and/or selectively varied (per demand). Thus providing and/or fine-tuning of the resonance frequency.

To provide suitable control on the refractive index of a waveguide structure, the technique of the present invention utilizes a charge storage layer structure (CSL) attached to the waveguide (e.g. located on top of the waveguide structure) and configured for generating electric field in the vicinity of the waveguide structure. Such electric field applied on the waveguide structure provides for varying the charge carrier's density within the waveguide structure resulting in a free carrier plasma effect inducing variation in the refractive index of the waveguide structure. The CSL structure is preferably configured to allow selective trapping of charged carriers to thereby provide stable electric field and eliminate the need for maintaining connection to a power source.

It should be understood that the present invention provides a novel approach for the refractive index variation of the waveguide structure, as compared to the conventionally used techniques such as the use of an electrode and controlling voltage thereon. On the contrary, the present invention utilizes the principles of electrostatics, by providing the CSL structure on top of the waveguides structure and controlling selective trapping of the charged carriers within the CSL, which creates the electric field within the waveguide structure. This eliminates, or at least significantly reduces the need for maintaining the device connection to an electric power source.

Generally, the CSL structure may be configured as metal-oxide-semiconductor (MOS) capacitor, configured with a charge trapping layer (charge storage compartment). Charge carriers trapped in the CSL structure (e.g. in an insulating layer or a floating gate of the MOS capacitor-like structure) apply electric field on the waveguide structure thereby varying charge carriers distribution therein. For example, the CSL structure may be configured as Silicon based oxide-nitride-oxide (ONO) structure or may include a floating electrode (gate), e.g. polysilicon floating gate. The controlled charge trapping may be performed by charge injection from the silicon or the gate either by tunneling or internal photo emission.

According to the present invention, the CSL structure is attached to the waveguide structure at least at one-side thereof and is configured to apply electric field on the waveguide structure defined by amount of charge stored in the CSL structure. More specifically, providing a selected amount of charge carriers (e.g., electrons) inside the CSL structure induces a corresponding electric field on the waveguide.

Applying electric field on a semiconductor waveguide structure may be used for varying surface charges therein and consequently changing refractive index of the waveguide structure's material by the free carrier plasma effect. This provides electric control over the refractive index of the waveguide structure or regions thereof (i.e. local change of the refractive index). For example, such control of the refractive index may be used for controlling and shifting the resonance frequency of a resonator waveguide structure (e.g. ring resonator) to a desired value. Additionally, or alternatively such control of the refractive index may be used in an interferometer structure, allowing selective variation of the optical path of light propagation within the waveguide, as well as controllable phase shifting of the light.

As indicated above, the present invention, utilizing a proper combination of the CSL structure, e.g. an ONO structure, with a waveguide structure, in the semiconductor device allows for affecting the refractive index of the waveguide by trapping charge carriers within the CSL structure and maintaining the desired variation in refractive index for a relatively very long period (tens of years). It should be noted that generally a CSL structure may be operated by injection of selective amount of charge carriers into a trapping layer thereof. The injected charge carriers remain in the trapping layer until additional charge carriers are injected and/or removed therefrom, i.e. until a change in the charge state of the CSL is initiated. Generally, the trapped charge may remain within the trapping layer for years and tens of years. Accordingly, the refractive index of the waveguide structure can be selectively adjusted to be desirably stable, and may be further changed when needed.

In addition, when needed, a gate electrode may be further provided in the device of the invention, configure to affect electric field on the CSL as well as on the waveguide, e.g. being on top of the CSL structure. The gate electrode can be used for further dynamically applying additional electric field on the waveguide structure, to further provide dynamic variation of the refractive index of the waveguide structure, in addition to the long-term tuning of the refractive index by the CSL structure. For example, the case may be such that the waveguide structure includes a cascade of coupled resonators. The refractive index and accordingly the resonance frequency of the resonators may be adjusted/set by the CSL, while the resonance frequency of at least one of the resonators may be varied, thus affecting the degree of coupling between the resonators (e.g. between “ON” and “OFF” states of coupling, e.g. for high Q-factor resonators) by controlling the voltage on the gate electrode to provide optical processing/switching. Additionally, the gate electrode may also be used in the process of charge injection into and out of the trapping layer of the CSL structure. Thus, generally, the refractive index controller arrangement in the semiconductor device includes the CSL structure (which may or may not include also a floating electrode), and possibly also an electrodes' arrangement including at least a gate electrode.

Thus, in addition to controlling the amount of trapped charge, the invention provides for selectively controlling over refractive index within the waveguide structure. This is while the use of an additional gate electrode and controlling of gate voltage applied thereon can be also used in fast shifting of the resonance frequency for switching and modulating the optical signals.

It should be noted that in order for effectively varying the refractive index within a waveguide, i.e. in a way that affects optical path of light propagation within the waveguides structure and/or resonance frequencies, a sufficient overlap between a region of the refractive index variation and optical mode of light propagation within the waveguide is to be provided. A mismatch between the optical mode and the region of refractive index variation might limit the achievable change in the refractive index. Generally, at least for basic modes the location of the optical mode is around the middle of the waveguide. This is while the location of the induced space charges (variation in charge distribution) is typically closer to the electric field source, being the CSL in this case. The present invention also provides the waveguide structure configurations that allow suitable penetration of the electric field, induced by the CSL and/or electrodes' arrangement, into the waveguide core to increase overlap between the region of the waveguide affected by the electric field to change the refractive index and the optical modes supported by the waveguide.

According to some embodiments of the invention, the waveguide structure may be configured with at least first and second regions of the same polarity but different doping concentration levels. For example the first region is configured is a thin layer with lower doping concentration with respect to the second layer and is located closer to the CSL. The second layer occupies the main portion of the waveguide structure and is doped with higher doping concentration level. This allows for the depletion region extending into the second layer, having higher doping concentration, to be thicker and reach the region of the optical mode. Thus, the use of patterned doping of the waveguide structure enables to provide efficient overlap between the formed depletion region and the optical modes of the waveguide structure.

According to some embodiments, the waveguide structure is configured to include at least one junction region (generally PN junction), obtained at the interface between differently doped regions of the waveguide structure. The junction region preferably extends across the waveguide structure towards the interface with the CSL. Applying reverse bias voltage to the junction region increases the depletion region in the waveguide structure, and accordingly increases the region of the waveguide structure being affected by the external electric field (e.g. applied by the CSL), providing that the change in refractive index is achieved at or close to the center of the waveguide (overlapping with the optical mode region).

According to some other aspects of the invention, two junction regions may be provided within a waveguide structure thereby forming a transistor-like structure. More specifically, utilizing a gate electrode or, as indicated above, a CSL structure on top of the waveguide structure, actually forms a MOS-like transistor. It should be noted, and as will be described further below, that, as the electrical characteristics of such transistor-like structure may be analytically correlated with a change in the refractive index provided by the CSL, the semiconductor device of the invention provides for electrical or electronic characterization and control of the optical properties of the waveguide structure.

Thus, the technique of the present invention provides a semiconductor optical device configuration enabling selective variation of the refractive index (i.e. selected refractive index profile) of selected region(s) of a waveguide structure by the use of trapped charges in the CSL structure, as well as real-time tuning thereof utilizing one or more gate electrodes associated with the waveguide structure. It should also be noted, that generally, the CSL structure may be configured as an array of charge storing units arranged in a spaced-apart relationship on top or in the vicinity of the waveguide therealong and be separately operable, thereby enabling desired local creation and tuning of the refractive index profile of the waveguide regions.

The technique of the present invention may be used for post production tuning of optical elements, as well as used in the operational process of suitable optoelectronic devices and systems. For example, refractive index variation in optical resonators, such as ring resonators, may be used for varying resonance frequency without the need for physically trimming the waveguide structure of the resonator. It should be noted that to facilitate understanding, the term trimming as used herein below refers to a permanent variation of resonance frequency of an optical resonator to a desired frequency, being different to physical trimming according to a physical change in a resonator structure is considered. The trimming effect allows for tuning and fine-tuning of resonance frequency to provide desired matching or mismatch between two or more resonators allowing various manipulations in signal transmission and processing. Generally, the technique of the invention allows fixed (certain profile) fine-tuning of resonance frequency of a ring resonator by providing trapped charge carriers in a CSL structure associated with the resonator, as well as dynamic variation of the resonance frequency. This allows coupling two or more such resonators to transmit a selected frequency and varying transmission of the coupled resonators by shifting resonance frequency of one or more of them to reduce and/or cut transmission.

Additionally, as noted above, selective controlling of the refractive index in a waveguide structure may be used for desired variation of the optical path of light passing therethrough. This may be used in interferometer based systems, e.g. Mach Zehnder interferometer, as well as in other types of structures such as photonic crystals, Bragg reflectors, microdisk resonators and others. To this end, controllable variation of the refractive index in selected regions of the waveguide structure may be used for controlling spectral response of the waveguide structure, e.g. compensating for manufacturing tolerances, etc. For example, the invention can be used to match the resonance of the photonic structures to that of the International Telecommunication Union (ITU) grid standards for telecommunication applications.

According to a particular exemplary embodiment, the technique of the invention enables for multiplexing and de-multiplexing multiple carrying wavelengths of a single optical fiber. More specifically, this allows for using multiple lasers integrated to the photonic chip by a single waveguide capable of carrying multiple wavelengths and using an optoelectronic device according to the present invention to selectively drop/extract specific wavelength(s) at specific location(s) along the fiber. It should be noted that such wavelength de-multiplexing is difficult to implement with the conventional approach due to unavoidable inaccuracies in resonance conditions of optical resonators.

Thus, according to a first broad aspect of the invention, there is provided a device, e.g. optical or optoelectronic device, comprising a semiconductor structure defining at least one waveguide and at least one charge storage structure attached to at least one side of the semiconductor structure. Each of the at least one charge storage structure comprising at least one charge storage compartment for trapping charge carriers, such that trapping a predetermined amount of charge carriers in said storage compartment induces a constant electric field within the semiconductor structure in the vicinity of said at least one waveguide, thereby controlling surface space charge in the semiconductor structure and altering an effective refractive index of said at least one waveguide.

According to some embodiments, the charge storage structure may comprise at least three layers comprising a first layer comprising silicon oxide, a second layer comprising silicon nitride and a third layer comprising silicon oxide, thereby defining an ONO structure, said silicon nitride layer defines said storage compartment.

According to some other embodiments, the charge storage structure may be configured as a floating gate structure; said floating gate comprises a polycrystalline semiconductor structure.

The device may further comprise a gate electrode attached to said charge storage structure, said gate electrode being configured such that applying voltage to said gate electrode induces additional electric field in the vicinity of said at least one waveguide thereby enabling dynamic change of the constant electric field thereby further altering refractive index of said at least one waveguide.

The semiconductor structure may comprise first and second doped regions within said least one waveguide. The first region is proximal to said charge storage structure and being doped to a lower level with respect to the second region thereby pushing surface space charges within the semiconductor structure further from said charge storage structure allowing overlap with optical mode supported by the waveguide, thereby enhancing the alteration of the effective refractive index of the semiconductor structure closer to the center of the optical modes of the waveguide.

According to some embodiments of the invention, the device may comprise at least one PN junction in the semiconductor structure at the vicinity of the charge storage structure (e.g. within the waveguide structure). The at least one PN junction generates a depletion region within the semiconductor structure thereby allowing to further increase variation is charge carrier density within said waveguide.

The device may comprise at least two PN junctions in the semiconductor, said at least two PN junctions defining a transistor-like configuration allowing electrical characterization of variation in refractive index of the semiconductor structure.

Generally, charge trapping in said charge storage compartment may be provided by at least one of the following: illuminating said structure in one or more predetermined wavelength ranges and applying predetermined voltage difference on said device.

According to one other broad aspect, the present invention provides a device (e.g. optical or optoelectronic device) comprising an electric field generator and a semiconductor structure defining at least one waveguide and comprising at least first and second doped regions, the first doped region being proximal to said electric field generator and being doped to a lower level with respect to the second region thereby pushing surface space charges within the semiconductor structure further from said electric field generator allowing overlap with optical mode supported by the waveguide, thereby enhancing alteration of an effective refractive index of said semiconductor structure closer to the center of the optical modes of the waveguide.

The device according may further comprise a charge storage structure located between said electric field generator and said first doped region of the semiconductor structure, said structure comprising a storage compartment for trapping charge carriers; storing a selected amount of charge carriers in said storage compartment induces a constant electric field on the semiconductor structure, thereby further controlling the surface space charge in the semiconductor structure by pushing the surface space charge closer to a center of the optical modes of the waveguide, thereby enhancing the alteration of the effective refractive index of the semiconductor structure and overlap with optical modes of the waveguide.

The semiconductor structure may comprise at least one PN junction located at the vicinity of said electric field generator, said at least one PN junction generates a depletion region within the semiconductor structure thereby allowing to further increase variation is charge carrier density within said waveguide.

According to some embodiments, the semiconductor structure may comprise silicon. Additionally, or alternatively, the semiconductor structure may comprise n-type semiconductor.

As generally described herein, the waveguide structure of the device according to the present invention may be configured as an optical resonator. For example, the waveguide structure may be configured as a ring resonator.

According to yet another broad aspect of the invention, the present invention provides a device comprising a semiconductor waveguide structure and at least one charge storing structure, said at least one charge storing structure being configured to apply selected electric field on the semiconductor waveguide structure to thereby vary refractive index within said semiconductor waveguide structure. The charge storing structure comprises a charge trapping layer configured for storing charge carriers to thereby selectively generate constant electric field of a predetermined magnitude.

The semiconductor waveguide structure may be configured to vary charge carrier density in response to electric field applied thereon thereby varying refractive index of the semiconductor waveguide structure. The semiconductor waveguide structure may be made of Silicon.

According to some embodiments, the semiconductor waveguide structure may comprise a first region configured with certain doping concentration and a second region configured with higher doping concentration, wherein said first region being closer to the charge storing structure than the first region to thereby allow variation of charge carrier distribution to overlap with optical mode within the waveguide structure.

According to some embodiments of the present invention, said charge storing structure may comprise a layered charge trapping structure comprising at least two external insulating layers and at least one internal charge accepting layer. For example, the charge storing structure may comprise a silicon oxide-silicon nitride-silicon oxide (ONO) layered structure configured to selectively trap charged within the silicon nitride layer.

According to yet some embodiments of the invention, the device may further comprise a gate electrode configured to selectively apply additional electric field on said semiconductor waveguide structure. The gate electrode may be placed on top of the charge storing structure such that said charge storing structure is between the gate electrode and the semiconductor waveguide structure. The gate electrode may be configured of poly-silicon structure.

It should be noted that the semiconductor waveguide structure may configured as a rib structure on a semiconductor layer, said charge storing structure is located on top of said rid structure. However additional configurations of the waveguide are possible, such as embedded in a substrate, slab waveguide and/or optical fiber configurations. In any configuration the charge storing layer may be attached to the waveguide from any direction as the case may be.

According to some embodiments, the semiconductor waveguide structure may comprise at least one third region doped with charge carriers of opposite charge with respect to core of said semiconductor waveguide structure, said at least one third region being located on at least one side with respect to the semiconductor waveguide structure. The at least on third region may define a PN junction with core of said semiconductor waveguide structure, thereby forming a depletion region within said semiconductor waveguide structure allowing to further increase variation is charge carrier density within said waveguide.

In some embodiments, the device may comprise two third regions located on either side of the semiconductor waveguide structure, thereby forming a transistor structure enabling electric verification of field generated by the charge storing structure.

Typically, the semiconductor waveguide structure may be configured as an optical resonator, such as ring resonator, photonic crystal resonator etc.

Alternatively, or additionally, the semiconductor waveguide structure may be configured for use in an interferometer structure and/or may be configured for use in a controlled phase shifter.

According to yet another broad aspect of the invention, there is provided an optoelectronic system comprising at least waveguide structure comprising at least one optical resonator, said at least waveguide structure comprising a charge storing structure located on said optical resonator; said charge storing structure is configured for selectively trapping charge carriers to thereby apply selected electric field on said waveguide structure thereby selectively tuning resonance frequency of said ring resonator waveguide structure.

One or more of the at least one ring resonator waveguide structures may further comprise a gate electrode enabling temporary variation of refractive index within said waveguide structure, thereby allowing short term variation of said resonance frequency within the ring resonator waveguide structure.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 exemplifies a device construction according to a first aspect of the invention;

FIG. 2 exemplifies a device construction according to a second aspect of the invention;

FIG. 3 exemplifies a device construction combining the features of the first and second aspects illustrated in FIGS. 1 and 2;

FIGS. 4A and 4B illustrate two configurations of optical resonators configured according to some embodiments of the invention and coupled to an optical waveguide;

FIGS. 5A to 5D illustrate results of an experiment conducted by the inventors; and

FIG. 6 illustrates an optoelectronic system utilizing a cascade of optical resonators and utilizing the technique of the present invention.

### DETAILED DESCRIPTION OF EMBODIMENTS

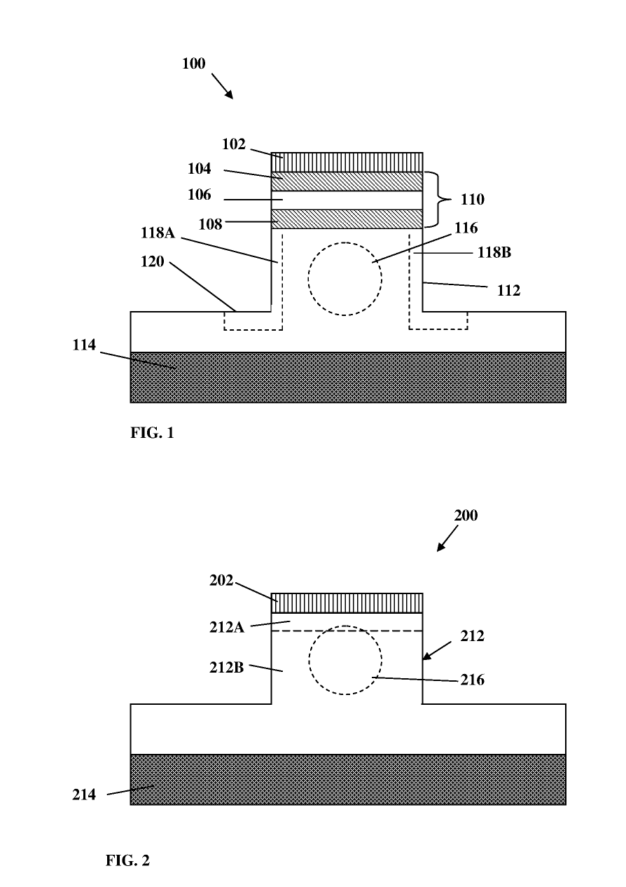

Reference is made to FIG. 1 showing a non-limiting example of a first embodiment according to the invention. Shown in the figure, is a transverse cross-section of a multilayer device 100 which includes a semiconductor waveguide structure 112 and at least one charge storage layered structure 110 (CSL) attached to at least one side (e.g. the upper side as shown) of the semiconductor waveguide structure (SWS) 112 (SWS). It should be noted that the waveguide structure 112 as illustrated in FIG. 1 and in the following examples is shown as a rib-like waveguide structure located on a substrate 114. It should however be note that the technique and configuration according to the present invention may be used for any type waveguide structure including slab waveguide structure, optical fiber configuration, rib-like structure as well as any other waveguide structure having at least one face. The semiconductor waveguide structure 112 is shown to support at least one optical mode 116 shown symbolically in dashed lines to indicate the approximate location of most of the optical energy at the middle of the SWS 112 indicating optical mode corresponding to TEM₀₀. It should be noted that the waveguide structure 112 may support additional optical modes. The waveguide structure 112 be configured to provide straight path for light propagation, as well as circular path (e.g. as in ring resonators), or may define any other suitable path for light passing therethrough. Typically, the semiconductor 112 is made from silicon, and the words semiconductor and silicon may be used interchangeably herein. The (CSL) structure 110 is placed in contact with SWS 112 and is generally configured for applying desired electric field on the waveguide structure 112 to thereby desirably vary refractive index of the SWS 112.

To this end, the CSL structure 110 is configured to store charge carriers to thereby induce the electric field on the SWS 112. Typically, the CSL 110 is capable of accepting charge carriers injected for storage and maintain the stored charge for a predetermined time period. For example, as shown in FIG. 1 the CSL 110 is made from three layers 104, 106 and 108, where the middle layer 106 functions as a storage compartment 106 for trapping charge carriers therein. Typically, the external two layers of the structure 104 and 108 are insulating layers configured to separate the stored charge carriers and prevent escape of the stored charge. For example, the CSL 110 may be configured as a Silicon-Oxide-Nitride-Oxide-Silicon (SONOS) structure, or Oxide-Nitride-Oxide (ONO) structure. More specifically, layers 104 and 108 may be made from silicon oxide (SiO₂), and the middle storage compartment layer 106 is made from silicon nitride (Si₃N₄). It should however be noted that any other charge storage layered structure suitable for storing charge and for applying electric field resulting from the stored charges may be used. The terms CSL and ONO are used herein below interchangeably for simplicity and should be interpreted broadly as charge storage structure.

As indicated above, the SWS 112 is exemplified here as a rib-type waveguide structure located on a substrate 114. The substrate 114 may be made of suitable oxide or any other material having refractive index lower with respect to the SWS 112 material composition (for predetermined desired wavelength range). Additionally, the substrate 114 is preferably electrically insulating.

Preferably, the device 100 also includes a gate electrode 102, preferably made from a thin layer of poly-silicon or metal. Optionally, the device 100 also includes one or two regions within the SWS 112 configured with doping opposite to the doping of the SWS 112 material, two such regions 118A and 118B are shown in the figure located at the vicinity of the waveguide 116 at both sides thereof. The different doping within the SWS 112 creates PN junctions at interfaces between the regions thereby creating and/or broadening a depletion region within the SWS 112. The function of these junctions will be further described below.

The middle silicon nitride layer 106 of the ONO structure 110 is configured for storing a predetermined amount of charge carriers which induces a constant, and permanent (i.e. for long time of tens of years), electric field on the semiconductor 112. Thus, the CSL structure 110 is capable of applying electric field to thereby controlling surface space charge in the SWS 112. Typically, the CSL structure 110 is configured for trapping electrons (of negative charge), however other CSL structure configurations may be used and may be configured for expelling electrons (thereby trapping holes or positive charge carriers).

Generally, charge injection into the charge storage structure 110, e.g. into ONO structure, may be provided in several techniques. A gate electrode 102 located on top of the CSL 110 may be biased to high positive (or negative) voltage, to thereby cause electrons to tunnel from the waveguide structure 112 (or from the trapping layer 106) through the insulating layer 108 and to the trapping layer 106 (or to the waveguide structure 112). This process results in selected amount of trapped electrons (holes) in the trapping layer 106.

Other charge injection methods utilize optical emission. Generally silicon absorbs in the UV range to generate free electrons at energy that is sufficiently high to tunnel into the charge trapping layer 106.

The charge accumulated in the CSL structure 110 generates an electric field and affects free charge carrier density within the SWS 112. Specifically, the electric field applied on the SWS 112 results in free surface space charge within the SWS 112 (e.g. forming a depletion region—region of the waveguide 112 with reduced density of free charge carriers) that affects the a refractive index of the waveguide. The amount and density of the surface space charge dictates the broadness of the depletion region inside the semiconductor.

As indicated above, the device 100 may include one or more regions of opposite doping, regions 118A and 118B as exemplified in the figure, defined herein as opposite charge regions. More specifically, if the semiconductor waveguides structure 112 is n-type semiconductor (e.g. n-type silicon); oppositely doped regions 118A and/or 118B are p-type semiconductor. An interface between regions of the semiconductor of opposite doping forms a PN junction thereby generation one or more corresponding depletion regions. Generally the one or more regions of opposite charge are located in the waveguide structure and extend to the interface with the CSL 110. This is to provide the depletion region at close vicinity to the CSL and pushing the space charge plasma effects deeper into the waveguide structure 112 to overlap with the optical modes supported thereby 116. The depletion region, pushing charge carrier density away therefrom, effectively enhance the effects of the electric field applied on the semiconductor material and thus providing greater variation in the refractive index of the SWS 112.

In some configurations, the one or more opposite charge regions 118A and 118B are configure to enable electrical connection thereto, e.g. through electrical port 120. This electrical connection port 120 may be used to provide reverse bias voltage on the corresponding opposite charge region enabling control over the depletion region and control over refractive index variation.

It should be noted that, although the use of a single region of opposite charge (e.g. 118A) may provide sufficient enhancement of the refractive index variation. As the production complexity in addition of two or more such regions is negligible, it may be preferred to provide the SWS 112 with two or more regions of opposite charge 118A and 118B. Provision of such two (or more) regions of opposite charges actually creates a P-N-P transistor structure, of a MOSFET transistor-like structure. In this configuration, the charges trapped in the CSL 110 operate as gate voltage and determining characteristics of the source-drain current. For example, p-type regions 118A and 118B act as source and drain, while the n-type region of the SWS 112 acts as channel and transmits current therethrough in accordance with voltage applied thereon by charges trapped in the CSL 110.

This transistor-like configuration provided on the device 100 enables electrical measurements corresponding to optical characteristics of the SWS 112, as well as suitable route for charge injection to the CSL 110. More specifically, a simple calibration process can provide correspondence between the source-drain current characteristics and corresponding refractive index of the SWS 112, both resulting from charges trapped in the CSL 110.

As indicated above, the present invention, is various embodiments thereof provides for affecting optical properties of the waveguide structure 112 by charge injection into the charge trapping layer 106 of the CSL structure 110. Generally, such charge injection may be provided in several methods, which will be described herein referring to the example of ONO structure operating as CSL structure 110. More specifically, one method may include ultra violet (UV) illumination of the waveguide structure 112 or a thin gate layer (e.g. gate electrode 102) of the device 100 while applying a negative bias voltage to the gate 102 (internal photo emission). In this method, the exact amount of trapped charge can be controlled by either the UV dose or by the amplitude of the gate bias voltage. Another method includes charge injection into the charge trapping layer 106 by applying negative bias voltage on an electrode (e.g. gate electrode 102) that is sufficiently high to enable charged carriers arriving from the waveguide structure 112 to tunnel through the insulating layer 108 and into the charge trapping layer (e.g. Silicon Nitride layer) 106.

Generally, the above describe charge injection methods as well as alternative methods are based on exciting charge carriers (electrons) with sufficient energy so that they are ejected from the valence band of the gate electrode 102 or from the semiconductor material of the waveguide structure 112 and tunnel through the conduction band of the corresponding insulating layer 104 or 108 to get trapped in the charge trapping layer 106 (e.g. silicon nitride). Generally, for the case of silicon nitride, electrons are trapped with at energetic state of about 2 eV below the conduction band of the silicon nitride. Such energetic state is typically about 1 eV below the conduction band of the insulating layers, which in such configuration may be made of silicon oxide. Additionally, one or more of the insulating layers (e.g. the silicon oxide layer(s)) may be erased and drained from the charge carriers by exciting electrons above the conduction band of the layer (of the silicon oxide) and shorting the device to provide a capacitor's gate electrode.

Reference is now made to FIG. 2 schematically illustrating a semiconductor device 200 according to one other non-limiting example of the present invention. The device 200 is illustrated in a transverse cross section and includes a waveguide structure 112 exemplified as a rib waveguide structure and an electric field generating unit 202 attached to the waveguide structure 212. The electric field generating unit 202 may be in the form of a CSL structure as described above and/or formed of or include a gate electrode. The waveguide structure 212 is formed of semiconductor material and includes first 212A and second 212B doped regions. The first doped region 212A is located proximal to the electric field generator 202 with respect to the second region 212B. The first 212A and second 212B regions are configured with selected different doping levels such that the doping level of the first doped region 212A is lower than that of the second doped region 212B. For example, in the non-limiting case of N-type doped silicon waveguide structure, the first doped region 212A may be configured with dopant concentration of about 10¹⁵ cm³ while the second doped region 212B may be configured with dopant concentration of 5·10¹⁵ cm³.

It should also be noted that the waveguide structure 212 may be configured to support optical modes regardless of the interface between the first 212A and second 212B doped regions. More specifically, optical modes 216 supported by the waveguide structure 212 may be within the second doped region 212B or extending between the first 212A and second 212B doped regions. This may be determined both by the optical mode structure as well as by the thickness of the first doped region 212A. In some configurations, the waveguide structure 212 may have thickness, i.e. between the substrate 214 and the electric field generating unit 202, of 150-300 nm, while the first doped region 212A may be configured with thickness of 5-30 nm The difference in doping concentration provides for reduced charge carrier density in the first doped region 212A. This configuration varies distribution of surface space charges induced by electric field provided from the electric field generating unit 202 deeper into the SWS 212 increasing overlap of regions affected by the electric field to vary refractive index thereof with optical mode supported by the SWS 212. Such overlap increases the effects of the applied electric field on light propagation in the SWS 212 and enables significant variation of the light propagation characteristics in the SWS 212 (e.g. phase induced to light components, resonance frequency etc.) for a given voltage provided by the electric field generating unit 202.

Generally, when voltage is applied by the electric field generator 202, surface space charges are accumulated in the semiconductor material of the SWS 212. The different doping level of the first 212A and second 212B doped regions provide larger charge density variation amounts in the more doped second region 212B. The magnitude of voltage varies the concentration of the surface space charge in the second doped region 212B, and consequently the width of the depletion layer is varied as well, such that higher accumulation of surface space charge pushes the depletion layer deeper towards the center of the optical mode 216 of the waveguide structure 212.

It should be noted, although not specifically shown in the figure, that the device 200 and particularly the SWS 212 thereof may also include one or more regions of opposite doping to generate PN junctions within the SWS 212. These regions are generally similar to regions 118A and 118B exemplified in FIG. 1 above.

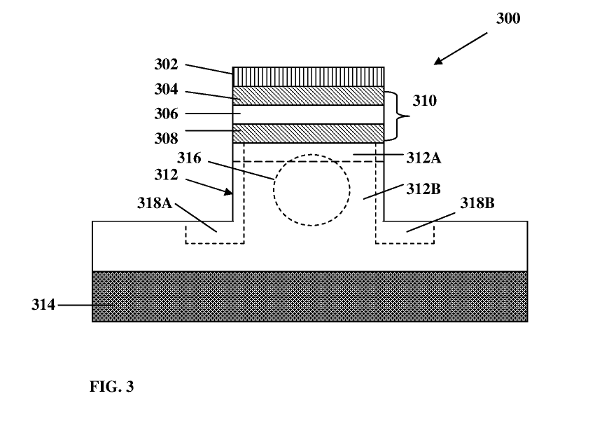

Reference is made to FIG. 3 schematically illustrating a semiconductor device 300 configured in accordance of the above described configuration of FIGS. 1 and 2 combined. Semiconductor device 300 includes a SWS 312 including first 312A and second 312B doped regions, and a CSL structure 310 attached to the SWS 312 and configured to apply electric field thereon by charge trapping. As indicated above, the SWS 312 is exemplified as a rib structure on an insulator substrate 314, however it should be noted that any other waveguide structure configuration may be used. The CSL 310 may similarly be configured as layered structure including a charge trapping layer 306 between insulating layers 304 and 308, and may be attached to an electrode (gate electrode) 302 which may be used for dynamic refractive index variation as well as to take part in charge injection into the charge trapping layer 306. The approximate location of optical modes 316 supported by the waveguide structure is also shown as a dashed circle. As described above, the optical modes may be within the second doped region 312B or extending between the first 312A and second 312B doped regions.

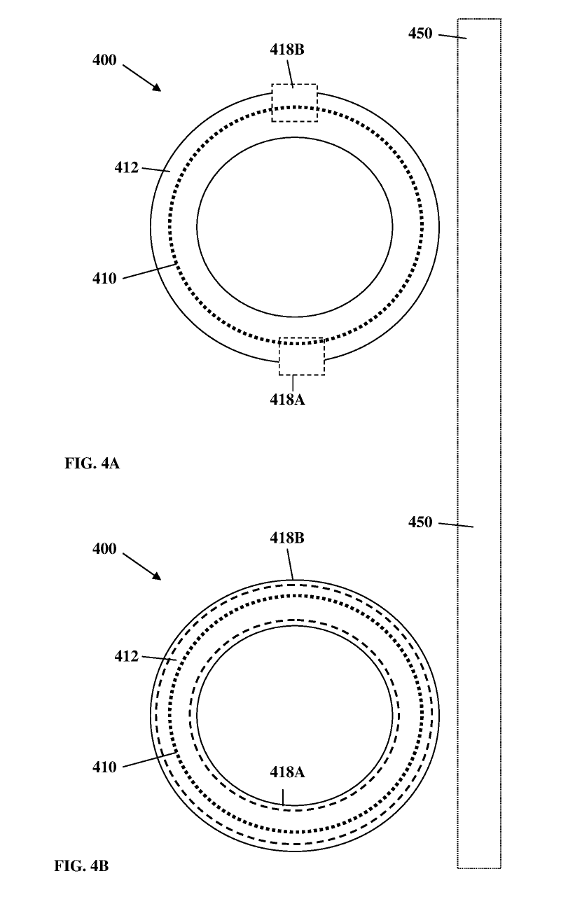

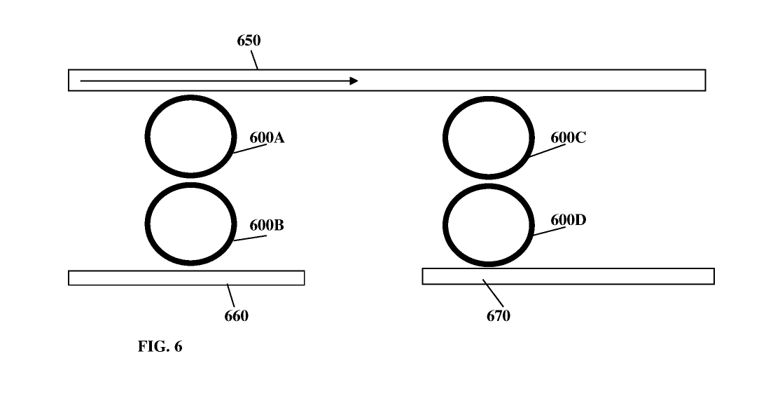

Thus, the semiconductor device, including a waveguide structure according to the present invention provides a simple a reliable control over refractive index of the waveguide structure. According to embodiments of the invention, such control may include both static variation of the refractive index by charge trapping in the charge storage structure, eliminating or at least significantly reducing the need for maintaining connection to a power source. Additional the device of the invention is capable of dynamic variation of the refractive index utilizing applied voltage on the device. It should be noted that such waveguide structure providing desirable control on refractive index thereof may be used in various optical and optoelectronic applications as will be described further with reference to FIGS. 4A and 4B and to FIG. 6.

The inventors have found, by various experiments and simulations several design options providing desired variation in refractive index within the waveguide structure in accordance with the above described configurations. For example, in some experimental exemplary configurations, the device utilizes a rib-structured waveguide structure having height of about 220 nm. Additionally, the CSL structure may be configured as a layered ONO based structure. For example having first oxide layer of 5-8 nm in thickness; nitride layer with thickness of about 9 nm; and allowing the upper oxide layer to be substantially thicker. It should be noted that when a gate electrode, e.g. electrode 102 or 302 is used on top of the CSL structure, the top oxide layer 104 or 304 should, at one side, keep the electrode gate 102 or 302 as far as possible from the waveguide to minimize any unwanted effects on the optical modes, such as losses to the optical signal, and on the other side, allow applied voltage from the gate electrode to affect the waveguide structure. For example, in application where no dynamic variation is needed, i.e. where a gate electrode is provided for purposes of charge trapping, the top insulating (oxide) layer may be thick, e.g. in the range of 200-300 nm, in order to prevent external interference on the optical modes of the waveguide structure. In such configuration, high voltages, such as about 20 volts, can be used for charge trapping to adjust the refractive index. This configuration may be used for example in optical resonators requiring high Q-factor (tens of thousands) where the resonator is trimmed for selected resonance frequency that need not be varied on demand and in real time. Alternatively, for application requiring dynamic variation of the refractive index (e.g. resonator based switch) the top insulating layer may be configured to be about 10 nm or less in thickness. This provides the gate electrode (102 or 302) to be closer to the waveguide structure and thus requires lower voltage for dynamic variation of the refractive index. It should be noted that the above measurements are provided to exemplify the technique of the invention utilizing a selected waveguide structure configuration and may vary in accordance with various parameters such as: materials used, desired wavelength to be passing through the waveguide, desired optical modes etc.

The inventors have found that utilizing the above structural parameters of the waveguide structure and charge storing structure may provide refractive index variation of about 10⁻³ as a result of trapped charge concentrations of about 5·10¹⁷ cm⁻³. Such variation in refractive index, when applied to an optical resonator, may be used to vary resonance frequency thereof in accordance with the relation Δn/n=Δλ/λ.

It should also be noted, that various configurations of bias voltage applied on the device may amplify and reduce the effects of trapped charges on the refractive index variation. For example, applying a positive reverse bias from the substrate (114, 214 or 314) direction can provide wider and deeper depletion region within the waveguide structure (112, 212 or 312) thereby amplifying the effects of negative charges trapped in the CSL (or negative voltage provided by the field generating unit 202). For example applying a reverse bias voltage of about 3 volt in the above described configuration, may produce as twice as wide depletion layer, thus enhancing the accuracy and effectiveness of the shifting in refractive index.

Reference is made to FIGS. 4A and 4B exemplifying two ring resonators 400 based on ring curved waveguide structures 412 configured according to the present invention. The ring resonators 400 include a CSL structure 410 located attached to the waveguide structures 412 (e.g. on top of the structure) and two regions of opposite doping within the waveguide structures (regions 418A and 418B). Additionally, one or more gate electrodes may be provided on top of the CSL structures 410, although not specifically shown in this figure. As indicated above, charge injection into the charge trapping layer of the CSL structure 410 can be used to vary refractive index of the waveguide structure and thus affecting resonance frequency of the resonators 400. The resonators 400 are shown in close proximity to a waveguide 450. This is to exemplify coupling of light from the waveguide 450 into the resonators 500. It should be noted that only light components having wavelength corresponding to a resonance frequency of the resonators 400 will couple into the resonator, while light components of different wavelength continue propagating in the waveguide 450.

In this connection FIGS. 4A and 4B exemplify two different configurations of the opposite doping regions 418A and 418B. As indicated above, these regions of opposite doping may be used both for charge injection into the CSL structure 410 as well as for electronic characterization of the resonator properties. In FIG. 4A, the opposite doped regions 418A and 418B are located at least two opposite locations across the circumference of the ring resonator 400, while in FIG. 4B, the opposite doped regions 418A and 418B are located along the whole circumference of the ring resonator from opposite sides of the CSL, as in the devices 100 to 300 above.

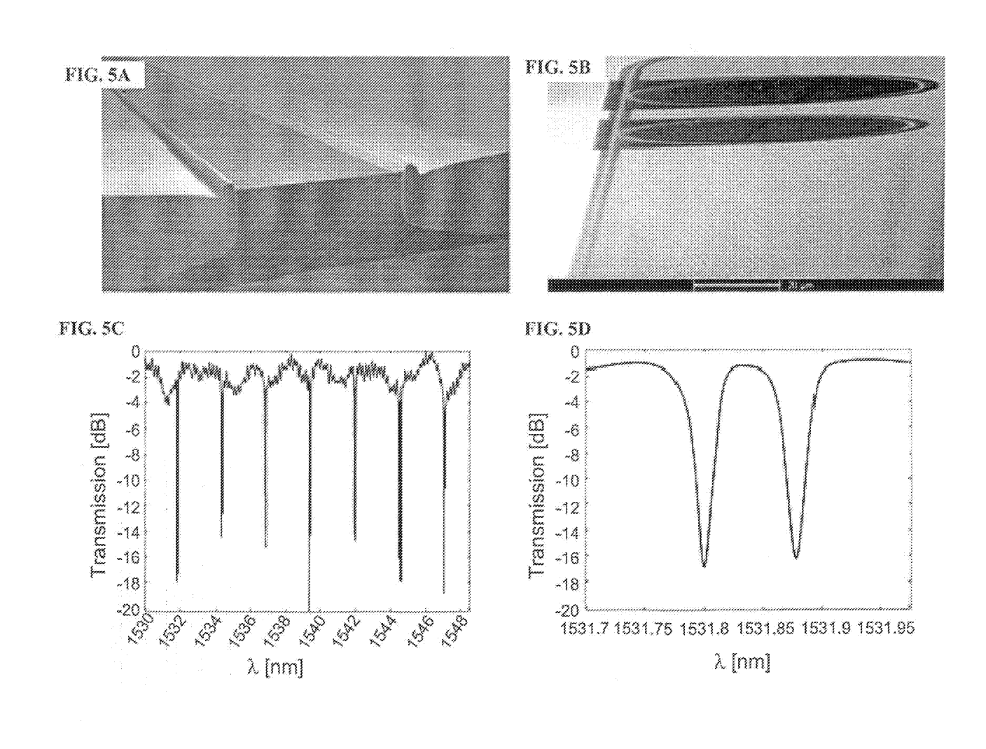

FIGS. 5A to 5D illustrate configuration and resonance frequency characteristics of ring resonator waveguides. FIG. 5A shows a waveguide structure embedded into a substrate; FIG. 5B shows two ring resonator waveguides coupled into a straight waveguide structure; FIG. 5C shows measured resonance frequencies of the ring resonators; and FIG. 5D compares resonance frequencies of the two resonators of FIG. 5B. The ring resonators shown in FIG. 5B are manufactures with similar dimensions in order to provide similar resonance frequency and allow coupling between them. As shown in FIG. 5C, the resonance frequencies are generally similar; however, zooming in on the resonance frequency around 1531.8 nm shows the differences caused by small variations between the ring resonators. As shown, the ring resonators are relatively high Q-factor resonators, having narrow band. Thus the small variation between the resonator structures resulting in shift in the resonance frequency eliminating the coupling between them.

Generally, such coupling between ring resonators may be achieved using physical trimming of the resonators until a frequency matching is achieved. The waveguide structure and device configuration of the present invention allows for “electronic” trimming of the resonators by trapping charges in the charge storage structure to desirably shift the resonance frequency and achieve coupling without the need for physical changes and/or without the need to reduce the Q-factor.

As indicated above, the semiconductor waveguide device and technique of the present invention may be used for various optical and optoelectronic applications. FIG. 6 exemplifies a use of the technique in optical resonator assembly to provide selective de-multiplexing and switch configurations. FIG. 6 illustrates an input waveguide 650, and two resonator pairs including resonators 600A, 600B and 600C, 600D, configured to selectively couple light components of desired wavelength ranges to corresponding output waveguides 660 and/or 670.

Generally, each pair of resonators, e.g. 600A and 600B are configures, by trapping appropriate charge in the corresponding CSL structures, to resonate at similar frequencies. This is provided to allow coupling of light of the desired frequency from waveguide 650, to resonator 600A, further to resonator 600B and further to waveguide 660. It should be noted, and as indicated above, that trimming of resonators to provide similar resonance frequencies utilizing the technique of the present invention is simple and changeable operation. Also, at any desired stage, the resonators may be re-trimmed to be coupled at a different selected resonance frequency by varying the charge trapped in the corresponding CSL structures.

Out coupling of light from waveguide 650 and into waveguide 660 may be turned off by applying desired electric field on an electrode associated with either one of resonators 600A or 600B to thereby vary resonance frequency thereof and destroy the coupling between the resonators. Alternatively, the resonators may be configured to be almost coupled, and suitable electric field applied to one of them may be used to turn the coupling on. This is similar for resonators 600C and 600D, which may be configured to out couple light of different wavelength from waveguide 650 and into waveguide 670.

Thus, the technique of the present invention provides a novel device configuration enabling selective variation of refractive index of a waveguide structure. As indicated, the device may be configured as an optical resonator and utilized in various optical and optoelectronic application, Additionally such device configuration may be used in interferometric application enabling desired adjustments to optical path of light passing through a selected waveguide region and/or to provide desired phase shift to light components. The technique of the invention utilized charge trapping techniques providing reliable effects for desirably long period of time, thereby eliminating, or at least significantly reducing the need to maintain voltage on selected electrodes.

1. A device comprising:
a semiconductor structure defining at least one waveguide,
at least one charge storage structure attached to at least one side of the semiconductor structure, each of the at least one charge storage structure comprising at least three layers comprising a first layer comprising silicon oxide, a second layer comprising silicon nitride and a third layer comprising silicon oxide, thereby defining an ONO structure, said silicon nitride layer defining a charge storage compartment configured for trapping charge carriers therein, and
a gate electrode attached to said at least one charge storage structure and being configured for charging said at least one charge storage structure with the charge carriers when applying predetermined voltage to said electrode, such that trapping a predetermined amount of charge carriers in said storage compartment induces a constant electric field within the semiconductor structure in the vicinity of said at least one waveguide, thereby controlling surface space charge in the semiconductor structure and altering an effective refractive index of said at least one waveguide.

2-3. (canceled)

4. The device according to claim 1, wherein said gate electrode is configured such that applying voltage to said gate electrode induces additional electric field in the vicinity of said at least one waveguide thereby enabling dynamic change of the constant electric field thereby further altering refractive index of said at least one waveguide.

5. The device according to claim 1, wherein said semiconductor structure comprises first and second doped regions within said least one waveguide, the first region being proximal to said charge storage structure and being doped to a lower level with respect to the second region thereby pushing surface space charges within the semiconductor structure further from said charge storage structure allowing overlap with optical mode supported by the waveguide, thereby enhancing the alteration of the effective refractive index of the semiconductor structure closer to the center of the optical modes of the waveguide.

6. The device according to claim 1, comprising at least one PN junction in the semiconductor structure at the vicinity of the charge storage structure, said at least one PN junction generates a depletion region within the semiconductor structure thereby allowing to further increase variation in charge carrier density within said waveguide.

7. The device according to claim 6, comprising at least two PN junctions in the semiconductor, said at least two PN junction defining a transistor-like configuration allowing electrical characterization of variation in refractive index of the semiconductor structure.

8. The device according to claim 1, wherein charge trapping in said charge storage compartment is provided by illuminating said structure in one or more predetermined wavelength ranges.

9.-11. (canceled)

12. The device according to claim 1, wherein said semiconductor structure comprises silicon.

13. The device according to claim 1, wherein said semiconductor structure comprises n-type semiconductor.

14. The device according to claim 1, wherein said charge carriers are electrons.

15. The device according to claim 1, wherein said waveguide is configured as an optical resonator.

16. The device according to claim 15, wherein said optical resonator is a ring resonator.

17.-23. (canceled)

24. The device according to claim 1, wherein said gate electrode is placed on top of the charge storage structure such that said charge storage structure is between the gate electrode and the semiconductor structure.

25. The device according to claim 1, wherein said gate electrode comprises a poly-silicon structure.

26. The device according to claim 1, wherein said semiconductor structure is configured as a rib structure on a semiconductor layer, said charge storage structure is located on top of said rib structure.

27. The device according to claim 1, wherein said semiconductor structure comprises at least one third region doped with charge carriers of opposite charge with respect to core of said semiconductor structure, said at least one third region being located on at least one side with respect to the semiconductor structure.

28. The device according to claim 1, wherein said semiconductor structure comprises at least one third region doped with charge carriers of opposite charge with respect to core of said semiconductor structure, said at least one third region being located on at least one side with respect to the semiconductor structure.

29. The device according to claim 1, wherein said semiconductor structure comprises at least one third region doped with charge carriers of opposite charge with respect to core of said semiconductor structure, said at least one third region being located on at least one side with respect to the semiconductor structure.

30.-31. (canceled)

32. The device according to claim 1, wherein said semiconductor structure is configured for use in an interferometer structure.

33. The device according to claim 1, wherein said semiconductor structure is configured for use in a controlled phase shifter.

34. An optoelectronic system comprising at least one waveguide structure comprising at least one optical ring resonator and a gate electrode, said at least one waveguide structure comprising a charge storing structure located on said optical ring resonator; said charge storing structure is configured for selectively trapping charge carriers to thereby apply selected electric field on said waveguide structure thereby selectively tuning resonance frequency of said ring resonator, said gate electrode enabling temporary variation of refractive index within said waveguide structure, thereby allowing short term variation of said resonance frequency within the ring resonator.

35. (canceled)

36. The device according to claim 1, wherein said trapping of the predetermined amount of charges carriers is provided by charge injection from the gate electrode by tunneling into said at least one charge storage structure.
